(19) United States
(12) Patent Application Publication
(10) Pub. No.: US 2012/0099976 A1
(43) Pub. Date: Apr. 26, 2012

(54) FAN CONTAINMENT SYSTEMS WITH IMPROVED IMPACT STRUCTURES

(75) Inventors: Justin C. Mickelsen, Gilbert, AZ (US); William H. Doddman, Phoenix, AZ (US); Bill Watson, Scottsdale, AZ (US)

(73) Assignee: HONEYWELL INTERNATIONAL INC., Morristown, NJ (US)

(21) Appl. No.: 12/912,268

(22) Filed: Oct. 26, 2010

(51) Int. Cl. F04D 29/40; B23P 17/00

(52) U.S. Cl. 415/182.1; 29/888

(57) ABSTRACT

Methods and apparatus are provided for a fan containment system for a gas turbine engine having a plurality of fan blades includes a cylindrical casing with an inner surface surrounding the plurality of fan blades and an opposing outer surface; a first layer of fabric material positioned on the exterior surface of the cylindrical casing; and a shear thickening fluid impregnated within the first layer of fabric material.

### TECHNICAL FIELD

The present invention generally relates to fan containment systems in gas turbine engines, and more particularly relates to fan containment systems in gas turbine engines with improved impact structures.

### BACKGROUND

A gas turbine engine is used to power various types of vehicles and systems. A particular type of gas turbine engine that may be used to power aircraft is a turbofan gas turbine engine. A turbofan gas turbine engine may include, for example, five major sections: a fan section, a compressor section, a combustor section, a turbine section, and an exhaust section.

The fan section is positioned at the inlet section of the engine and includes a fan that induces air from the surrounding environment into the engine and accelerates a fraction of this air toward the compressor section. The compressor section raises the pressure of the air it receives from the fan section and directs a majority of the high pressure air into the combustor section. In the combustor section, the high pressure air is mixed with fuel and combusted. The high-temperature combusted air is then directed into the turbine section where it expands through and rotates each turbine to drive various components within the engine or aircraft. The air is then exhausted through a propulsion nozzle disposed in the exhaust section.

At times, portions of the fan may become detached from a fan blade or rotor. It is known to provide a fan containment system with a casing surrounding the fan section to prevent these portions from escaping the engine. It is generally desirable to maximize the strength of these fan casings. However, the fan casing is usually fabricated from a metallic material, and increasing the thickness of the casing, adding additional structures, or other strengthening mechanisms may increase the overall weight of the engine, which may undesirably decrease engine efficiency.

Accordingly, it is desirable to provided fan containment systems with improved impact resistance without unduly increasing the weight of the fan section and the engine. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a fan containment system for a gas turbine engine having a plurality of fan blades includes a cylindrical casing with an inner surface surrounding the plurality of fan blades and an opposing outer surface; a first layer of fabric material positioned on the exterior surface of the cylindrical casing; and a shear thickening fluid impregnated within the first layer of fabric material.

In accordance with another exemplary embodiment, a method is provided for providing impact protection in a fan section of a gas turbine engine. The method includes providing a first layer of fabric material; applying a shear thickening fluid to the first layer of fabric material; and installing the first layer of fabric material with the shear thickening fluid onto a fan casing of the fan section.

### BRIEF DESCRIPTION OF THE DRAWINGS

The present invention will hereinafter be described in conjunction with the following drawing figures, wherein like numerals denote like elements, and wherein

FIG. 1 is a partial, cross-sectional view of a gas turbine engine in accordance with an exemplary embodiment;

FIG. 2 is a close-up cross-sectional view of a portion of the gas turbine engine of FIG. 1; and

FIG. 3 is a more detailed schematic cross-sectional view of a fan containment system of the gas turbine engine of FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Broadly, exemplary embodiments discussed herein provide improved fan containment systems for gas turbine engines. An exemplary fan containment system includes a casing that surrounds the fan section of the engine and an impact structure mounted on an exterior or outer surface of the casing. The impact structure is made up of a number of material layers impregnated with a shear thickening fluid for improving impact absorption.

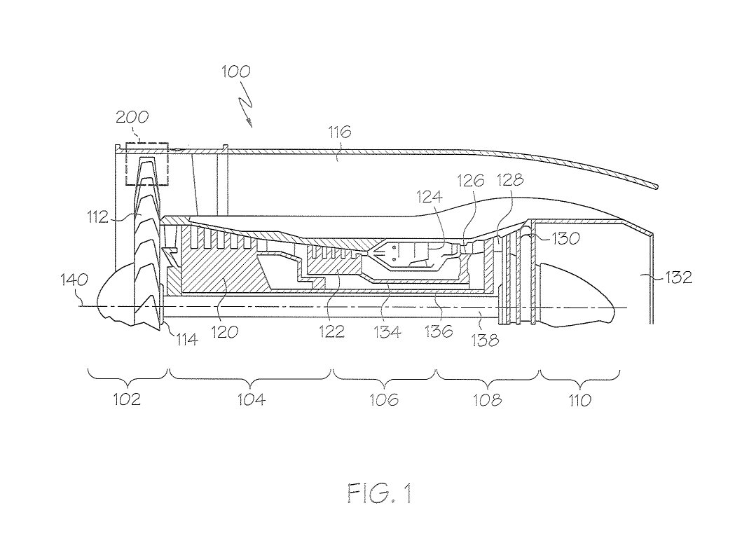

FIG. 1 is a partial, cross-sectional view of a gas turbine engine 100 in accordance with an exemplary embodiment with the remaining portion of the gas turbine engine 100 being axi-symmetric about a longitudinal axis 140. In the depicted embodiment, the gas turbine engine 100 is an annular multi-spool turbofan gas turbine jet engine 100 within an aircraft, although other arrangements and uses may be provided.

The engine 100 includes fan section 102, a compressor section 104, a combustor section 106, a turbine section 108, and an exhaust section 110. The fan section 102 includes a fan 112 mounted on a rotor 114 that draws air into the engine 100 and accelerates it. A portion 200 of the fan section 102 is discussed in greater detail below. A fraction of the accelerated air exhausted from the fan 112 is directed through a bypass section 116 and the remaining fraction of air exhausted from the fan 112 is directed into the compressor section 104.

In the embodiment of FIG. 1, the compressor section 104 includes an intermediate pressure compressor 120 and a high pressure compressor 122. However, in other embodiments, the number of compressors in the compressor section 104 may vary. In the depicted embodiment, the intermediate pressure compressor 120 and the high pressure compressor 122 sequentially raise the pressure of the air and directs a majority of the high pressure air into the combustor section 106. A fraction of the compressed air bypasses the combustor section 106 and is used to cool, among other components, turbine blades in the turbine section 108.

In the combustor section 106, which includes an annular combustor 124, the high pressure air is mixed with fuel and combusted. The high-temperature combusted air is then directed into the turbine section 108. In the embodiment of FIG. 1, the turbine section 108 includes three turbines disposed in axial flow series, namely, a high pressure turbine 126, an intermediate pressure turbine 128, and a low pressure turbine 130. However, it will be appreciated that the number of turbines, and/or the configurations thereof, may vary. In the embodiment depicted in FIG. 1, the high-temperature combusted air from the combustor section 106 expands through and rotates each turbine 126, 128, and 130. The air is then exhausted through a propulsion nozzle 132 disposed in the exhaust section 110. As the turbines 126, 128, and 130 rotate, each drives equipment in the engine 100 via concentrically disposed shafts or spools. Specifically, the high pressure turbine 126 drives the high pressure compressor 122 via a high pressure spool 134, the intermediate pressure turbine 128 drives the intermediate pressure compressor 120 via an intermediate pressure spool 136, and the low pressure turbine 130 drives the fan 112 via a low pressure spool 138.

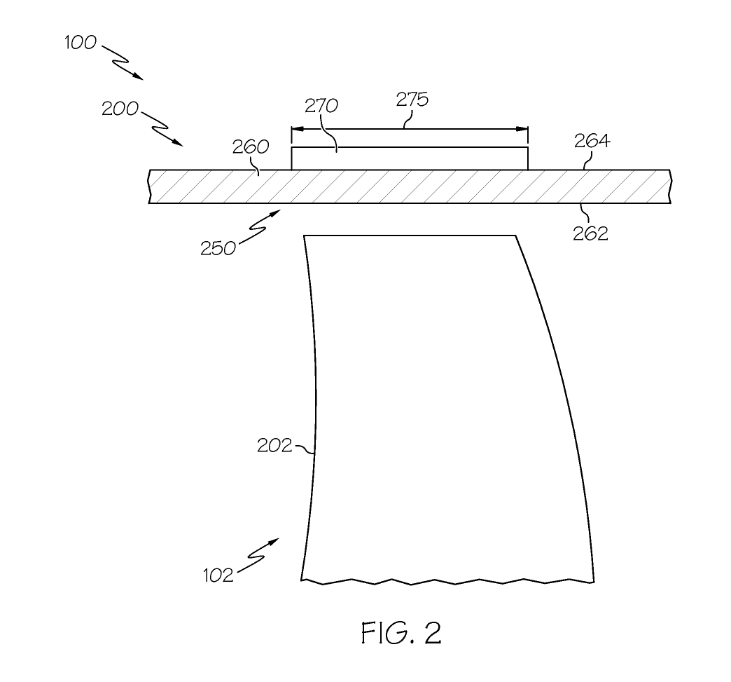

FIG. 2 is a close-up cross-sectional view of the portion 200 of the fan section 102 of the engine 100 of FIG. 1. As discussed above, the fan section 102 includes an array of fan blades 202 extending radially outward from a rotor 114 (FIG. 1). As the fan blades 202 rotate, air is drawn into the engine 100.

During operation, portions of the fan blades 202 may become detached from the fan blades 202 or rotor 114 (FIG. 1) of the fan section 102. To prevent these portions from escaping the fan section 102, a fan containment system 250 is provided. The fan containment system 250 generally includes a casing 260 and an impact structure 270. The casing 260 has an inner surface 262 and an outer surface 264 and is cylindrically shaped to circumscribe the rotating fan blades 202. The casing 260 may extend the entire axial length of the fan section 102 or only a portion thereof. Typically, the casing 260 is fabricated from a metallic material, although other materials may be used. Although not shown, one or more stiffening rings may also be provided.

The impact structure 270 is mounted on or otherwise secured to the outer surface 264 of the casing 260. As described below, the impact structure 270 and casing 260 cooperate to absorb at least some of the kinetic energy of any detached fan portions, thereby reducing the likelihood of these portions traveling out of the fan section 102, particularly in a radial direction out of the engine 100. The impact structure 270 may have an axial length 275 that is greater than the axial length of the fan blade 202, particularly in the aft direction, which is also the area where a detached portion of the fan blade 202 will likely impact. In other embodiments, the impact structure 270 has an axial length 275 approximately equal to the axial length of the fan blade 202. In an alternate embodiment, the impact structure 270 (or an additional impact structure) is mounted on the inner surface 262 of the casing 260. During a fan detachment event, the impact structure 270 may deform radially outward to absorb kinetic energy. Additionally, although FIG. 2 depicts the impact structure 270 mounted directly (or connected) to the casing 260, other embodiments may include the impact structure 270 indirectly attached to the casing 260 via intermediate layers or structures. In any event, the impact structure 270 is coupled to the casing 260 to absorb kinetic energy. The coupling may be rigid, flexible or rotatable.

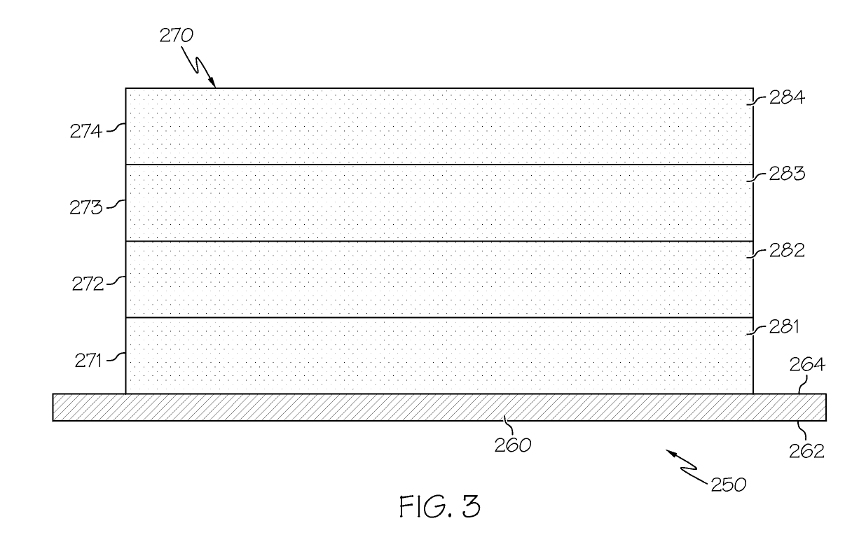

FIG. 3 is a more detailed schematic cross-sectional view of the fan containment system 250 of the engine 100 of FIG. 1. As shown in FIG. 3, the impact structure 270 is made up of a stack of radially disposed material layers (or windings) 271, 272, 273, and 274. The term material layer describes a planar arrangement of non-woven or woven fibers or yarns that have been consolidated into a single unitary structure, i.e. a single ply. Such layers may include weaves, braids, windings and unidirectional forms. In one exemplary embodiment, each layer is uni-directional material lightly stitched together and was conducive to a modified filament winding setup. Although not shown, the material layers 271, 272, 273, and 274 of the impact structure 270 may be enclosed or partially enclosed by a housing structure, for example, with a metallic or plastic skin. In one particular embodiment, the material layers 271, 272, 273, and 274 of the impact structure 270 may be enclosed or partially enclosed by the fan containment housing (not shown).

Each of the material layers 271, 272, 273, and 274 may be wound around the exterior of the casing 260. As shown, material layer 271 is mounted directly on the casing 260, material layer 272 is attached to material layer 271, material layer 273 is attached to material layer 272, and material layer 274 is attached to material layer 273. Although four material layers 271, 272, 273, and 274 are illustrated, any number of material layers may be provided based on weight and performance considerations. The layers 271, 272, 273, and 274 can be attached in several ways including any combination of the following: mechanical fastening of layer(s) to casing(s), adhesive bonding of layer(s) to casing(s), adhesive bonding along longitudinal edge(s) of one layer to an adjacent layer over a given area, adhesive bonding of one layer to an adjacent layer over a given area and spaced over a given distance in the axial direction (normal to the longitudinal direction), or no adhesive bonding between layer(s), i.e., held together by pressure or friction upon assembly.

As noted above, the material layers 271, 272, 273, and 274 may be fabricated as a network of fibers that have been formed into a fabric material. In particular, the material layers 271, 272, 273, and 274 are made up of high strength and high modulus fibers. For example, the fibers that make up the material layers 271, 272, 273, and 274 may be para-aramid synthetic fibers, such as KEVLAR fibers, which are sold by E.I. duPont de Nemours and Company. Non-limiting examples of other high strength fibers include metal fibers, ceramic fibers, glass fibers, carbon fibers, boron fibers, p-phenylenetherephtalamide fibers, aromatic polyamide fibers, silicon carbide fibers, graphite fibers, nylon fibers, and mixtures thereof. Another example of suitable fibers includes ultra high molecular weight polyethylene, such as SPECTRA fibers manufactured by Honeywell International Inc. The material layers 271, 272, 273, and 274 may be identical or different in composition or arrangement. In one exemplary embodiment, the material layers 271, 272, 273, and 274 may include, for example, 30 layers of para-aramid fabric wrapped in one continuous piece around the outside of the casing 260.

Typically, the fibers of the material layers 271, 272, 273, and 274 may have high tensile strength and high modulus that are highly oriented, thereby resulting in very smooth fiber surfaces exhibiting a low coefficient of friction. Such fibers, when formed into a fabric layer, generally exhibit poor energy transfer to neighboring fibers during an impact event. Unless addressed, this lack of energy transfer may correlate to a reduced efficiency in dissipating the kinetic energy of a moving object, thereby necessitating the use of more material to achieve full dissipation.

Accordingly, one or more of the material layers 271, 272, 273, and 274 is respectively impregnated with a shear thickening fluid 281, 282, 283, and 284 to improve the impact resistance of the impact structure 270. In the exemplary embodiment, all of the material layers 271, 272, 273, and 274 are respectively impregnated with the shear thickening fluid 281, 282, 283, and 284 throughout the entire thicknesses. In other embodiments, only a portion of the material layers 271, 272, 273, and 274 or only certain material layers 271, 272, 273, and 274 are impregnated with the shear thickening fluid 281, 282, 283, and 284. For example, in one exemplary embodiment, only the outermost material layer (e.g., material layer 274) and/or the innermost material layer (e.g., material layer 271) may be impregnated with shear thickening fluid 281.

In general, the shear thickening fluid 281, 282, 283, and 284 is non-Newtonian, dilatant, and flowable liquid containing particles suspended in a carrier whose viscosity increases with the deformation rate. These characteristics increase the energy transfer between the fibers within the material layers 271, 272, 273, and 274 as the rate of deformation increases. Such energy transfer may be embodied as strain, strain rate, vibration, both frequency and magnitude dependent, pressure, energy (i.e. low force over large distance and high force over short distance both induce a response) as well as energy transfer rate (higher rates induce greater response). As such, at low deformation rates, the material layers 271, 272, 273, and 274 with the shear thickening fluids 281, 282, 283, and 284 may deform as desired for handling and installation. However, at high deformation rates, such as during an impact or damage event, the material layers 271, 272, 273, and 274 with the shear thickening fluids 281, 282, 283, and 284 transition to more viscous, in some cases rigid, materials with enhanced protective properties. Accordingly, the material layers 271, 272, 273, and 274 impregnated with the shear thickening fluids 281, 282, 283, and 284 advantageously provide an impact structure 270 that is workable, light and flexible during installation, but that is rigid and protective during impact.

As noted above, the shear thickening fluid 281, 282, 283, and 284 generally includes particles suspended in a solvent. Any suitable concentration may be provided, and in one example, the shear thickening fluid 281, 282, 283, and 284 includes at least about 50 percent by weight particles. Exemplary particles may include fumed silica, kaolin clay, calcium carbonate, and titanium dioxide, and exemplary solvents include water and ethylene glycol. The particles of the shear thickening fluid 281, 282, 283, and 284 may be any suitable size to impregnate between the fibers of the material layers 271, 272, 273, and 274. For example, the particles may be nanoparticles, having an average diameter ranging from about 1 to about 1000 nanometers, or microparticles, having an average diameter ranging from about 1 to about 1000 microns.

Further examples of the particles of the shear thickening fluid 281, 282, 283, and 284 include polymers, such as polystyrene or polymethylmethacrylate, or other polymers from emulsion polymerization. The particles may be stabilized in solution or dispersed by charge, Brownian motion, adsorbed. Particle shapes may include spherical particles, elliptical particles, or disk-like particles.

The solvents are generally be aqueous in nature (i.e. water with or without added salts, such as sodium chloride, and buffers to control pH) for electrostatically stabilized or polymer stabilized particles. The solvents may be organic (such as ethylene glycol, polypropylene glycol, glycerol, polyethylene glycol, ethanol) or silicon based (such as silicon oils, phenyltrimethicone). The solvents can also be composed of compatible mixtures of solvents, and may contain free surfactants, polymers, and oligomers. The solvent of the shear thickening fluid 281, 282, 283, and 284 is generally stable so as to remain integral to the material layers 271, 272, 273, and 274. For a general preparation, the solvent, particles, and, optionally, a setting or binding agent are mixed and any air bubbles are removed.

The shear thickening fluid 281, 282, 283, and 284 may be embedded into the material layers 271, 272, 273, and 274 in a number of ways. For example, the shear thickening fluid 281, 282, 283, and 284 may be applied by individually coating the material layers 271, 272, 273, and 274 with techniques such as knife-over-roller, dip, reverse roller screen coaters, application and scraping, spraying, and full immersion. The material layers 271, 272, 273, and 274 may undergo further operations, such as reaction/fixing (i.e. binding chemicals to the substrate), washing (i.e. removing excess chemicals and auxiliary chemicals), stabilizing, and drying. For example, the fibers of the material layers 271, 272, 273, and 274 may be bound with the shear thickening fluid 281, 282, 283, and 284 with a thermosetting resin that may be cured with ultraviolet (UV) or infrared (IR) radiation. Generally, such curing will not result in the hardening of the material layers 271, 272, 273, and 274 and the shear thickening fluid 281, 282, 283, and 284, such that the material layers 271, 272, 273, and 274 remain workable until installation. Additional coatings may be provided, such as to make the material layers 271, 272, 273, and 274 fireproof or flameproof, water-repellent, oil repellent, non-creasing, shrink-proof, rot-proof, non-sliding, fold-retaining, antistatic, or the like.

The material layers 271, 272, 273, and 274 may be impregnated with the shear thickening fluid 281, 282, 283, and 284 prior to installation, for example, as a prepreg in which the impregnated with shear thickening fluid packaged and sold as a roll of continuous material. A length of the material layers 271, 272, 273, and 274 may be sized, cut and installed, and as many layers as desired may follow. Because the shear thickening fluid 281, 282, 283, and 284 is flowable and deformable, it can fill complex volumes and accommodate bending and rotation. These materials provide flexible and conformable protective impact structures 270.

Accordingly, exemplary embodiments of the fan containment system 250 dissipate the kinetic energy of moving objects, thereby preventing or reducing the likelihood of those moving objects exiting the fan section 102. The impact structure 270 thus provides the designer of an aircraft engine with the ability to optimize containment performance and weight with improved impact resistance and damage tolerance properties. Additionally, a designer may be able to reduce the number of material layers of fabric while achieving such improved containment performance. The use of fewer layers has the advantage of reducing the weight that is carried by the engine for improved engine performance and reduced fuel consumption.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An fan containment system for a gas turbine engine having a plurality of fan blades, the fan containment system comprising:
a cylindrical casing with an inner surface surrounding the plurality of fan blades and an opposing outer surface;
a first layer of fabric material coupled to the exterior surface of the cylindrical casing; and
a shear thickening fluid impregnated within the first layer of fabric material.

2. The fan containment system of claim 1, further comprising additional layers of fabric material coupled to the first layer.

3. The fan containment system of claim 2, wherein the shear thickening fluid is impregnated into the additional layers.

4. The fan containment system of claim 1, wherein the shear thickening fluid has a viscosity that is a function of deformation rate.

5. The fan containment system of claim 1, wherein the shear thickening fluid has dilatant properties.

6. The fan containment system of claim 1, wherein the first layer of fabric material contains at least one of aramid fibers, graphite fibers, nylon fibers, polyethylene fibers, or glass fibers.

7. The fan containment system of claim 1, wherein the shear thickening fluid contains particles suspended in a solvent.

8. The fan containment system of claim 7, wherein the particles include at least one of silica, clay, or calcium carbonate.

9. The fan containment system of claim 7, wherein the particles include at least one of fumed silica, kaolin clay, or calcium carbonate.

10. The fan containment system of claim 7, wherein the carrier includes at least one of ethylene glycol, polypropylene glycol, glycerol, and water.

11. The fan containment system of claim 7, further comprising a binding agent configured to secure the shear thickening fluid to the fabric material.

12. A method of providing impact protection in a fan section of a gas turbine engine, the method comprising the steps of:
providing a first layer of fabric material;
applying a shear thickening fluid to the first layer of fabric material; and
installing the first layer of fabric material with the shear thickening fluid onto a fan casing of the fan section.

13. The method of claim 12, further comprising the steps of providing additional layers of fabric material and installing the additional layers onto the first layer.

14. The method of claim 13, further comprising the step of applying the shear thickening fluid to the additional layers.

15. The method of claim 12, wherein the providing step includes forming the first layer of fabric material with at least one of aramid fibers, graphite fibers, nylon fibers or glass fibers.

16. The method of claim 12, wherein the applying step includes applying the shear thickening fluid as particles suspended in a solvent.

17. A fan section of a gas turbine engine, comprising:
a rotor;
a plurality of fan blades mounted on the rotor;
a casing circumscribing the plurality of fan blades, the casing having an inner surface and an opposing outer surface;
a first layer of fabric material mounted onto the outer surface of the casing; and
a shear thickening fluid embedded within the first layer of fabric material.

18. The fan section of claim 17, further comprising additional layers of fabric material layered on the first layer of fabric material.

19. The fan section of claim 18, wherein the shear thickening fluid is embedded within the additional layers.

20. The fan section of claim 17, wherein the shear thickening fluid has a viscosity that is a function of deformation rate.
